(19) United States
(12) Patent Application Publication
(10) Pub. No.: US 2011/0105355 A1
(43) Pub. Date: May 5, 2011

(54) BORRELIA BURGDORFERI CELL ENVELOPE PROTEIN ARRAY

(75) Inventors: Benjamin J. Luft, Riverhead, NY (US); Yun Xu, Stony Brook, NY (US); John F. Bruno, Islip, NY (US)

(73) Assignee: RESEARCH FOUNDATION OF STATE UNIVERSITY OF NEW YORK, ALBANY, NY (US)

(21) Appl. No.: 12/989,003

(22) PCT Filed: Apr. 21, 2009
(86) PCT No.: PCT/US09/02474

§ 371 Date: Dec. 10, 2010

Related U.S. Application Data
(60) Provisional application No. 61/125,040, filed on Apr. 22, 2008.

(51) Int. Cl. C40B 30/04; C40B 40/10

(52) U.S. Cl. 506/9; 506/18

(57) ABSTRACT

Methods of assessing a sample for the presence of antibodies to cell envelope proteins of Borrelia burgdorferi, are described, as are methods of diagnosing Lyme disease. Microarrays of cell envelope proteins of Borrelia burgdorferi are also described.

### RELATED APPLICATION

This application claims the benefit of U.S. Provisional Application No. 61/125,040, filed on Apr. 22, 2008. The entire teachings of the above application are incorporated herein by reference.

### BACKGROUND OF THE INVENTION

Lyme disease is the most common vector-borne disease in North America and Europe, and its range and incidence are increasing. Human Lyme disease is caused by several members of a group of closely related spirochetes belonging to the Borrelia burgdorferi sensu lato species complex. The spirochete is transmitted to humans via ticks of the genus Ixodes (Steere, A. C., N. Engl. J. Med. 1989; 321:586-96). It is a progressive multisystem disorder characterized by an initial cutaneous infection that can spread early in infection to secondary sites that include the nervous system, heart and joints (Masuzawa, T. et al., Microbiol. Immunol. 1996; 40:539-45; Stanek, G., Infection 1991; 19:263-7). The accurate diagnosis and treatment of Lyme disease depends on correlating objective clinical abnormalities with serological evidence of exposure to B. burgdorferi.

### SUMMARY OF THE INVENTION

The present invention is drawn to methods of assessing-a test sample from an individual for antibodies to one or more cell envelope proteins of Borrelia burgdorferi, such as one or more of the proteins shown in Table 1 or in Table 2. The methods can include the use of a microarray of cell envelope proteins of B. burgdorferi, such as a microarray including the proteins shown in Table 1 or in Table 2, or subsets thereof. The invention is further drawn to methods of diagnosing Lyme disease in an individual, by assessing a test sample from the individual for antibodies to one or more cell envelope proteins of B. burgdorferi, wherein the presence of the antibodies is diagnostic for disease. The invention is additionally drawn to microarrays of cell envelope proteins of B. burgdorferi, such as microarrays useful in the methods.

### DETAILED DESCRIPTION OF THE INVENTION

A description of example embodiments of the invention follows.

It has been discovered that antibodies to certain cell envelope proteins are present in sera of individuals with disseminated Lyme disease. A microarray containing proteins encoded by 90 cell envelope proteins and their homologs was prepared. The microarray was exposed to sera from individuals previously diagnosed with disseminated Lyme disease. Results indicated that the sera of individuals with Lyme disease reacted with specific cell envelope proteins including those shown in Table 2. In particular, high numbers of the sera from the individuals reacted with a specific subset of those proteins—those shown in Table 1. None of the control sera from individuals without Lyme disease, reacted with the proteins of Tables 1 or 2.

As a result of this discovery, methods and microarrays are now available for the assessment of a test sample for the presence of antibodies to proteins of Borrelia. The presence of such antibodies is diagnostic for Lyme disease. In addition, methods are available to identify potential diagnostic and vaccine candidates relating to Lyme disease.

In the methods and the microarrays of the invention, one or more cell envelope proteins are used. In certain embodiments, a set of two or more cell envelope proteins are used. Representative sets include the set of proteins shown in Table 2, and the set of proteins shown in Table 1. Other representative sets of cell envelope proteins include the set of all known and putative cell envelope proteins of B. burgdorferi. Such a set can further include homologs and paralogs of the cell envelope proteins. Other sets include sets of two or more, three or more, four or more, five or more, six or more, seven or more, eight or more, or other groups of cell envelope proteins (e.g., selected from those set forth in Table 2 or in Table 1). In one particular embodiment, the set consists essentially of the proteins set forth in Table 2. In another particular embodiment, the set consists essentially of the proteins set forth in Table 1.

In one embodiment of the invention, a test sample from an individual is assessed for the presence of antibodies to one or more cell envelope proteins of B. burgdorferi The “test sample” is a sample of blood, serum, cerebrospinal fluid, or other appropriate biological fluid from the individual. In the methods, the test sample is assessed for the presence of antibodies to one or more cell envelope proteins using routine methods established in the art. In one particular embodiment, the assessment is performed using a microarray of cell envelope proteins. In certain methods, for example, a microarray as described below, or a cell envelope protein or set of cell envelope proteins as described herein, is exposed to the test sample from the individual, and any resultant binding of antibodies (if present in the test sample) to the proteins is assessed. The presence of binding of antibodies to one or more cell envelope proteins is indicative of antibodies to one or more cell surface proteins of B. burgdorferi. The presence of such antibodies is diagnostic for Lyme disease in the individual from whom the test sample was obtained.

The present invention also pertains to microarrays of cell envelope proteins of B. burgdorferi. In one embodiment, the microarray consists essentially of all known and putative cell envelope proteins of B. burgdorferi. In another embodiment, the microarray comprises a subset of all known and putative cell envelope proteins of B. burgdorferi, such as the set the proteins set forth in Table 2. In a further embodiment, the microarray comprises a subset of the proteins set forth in Table 2 (e.g., the set of proteins set forth in Table 1). In other embodiments, other microarrays include various subsets of cell envelope proteins of B. burgdorferi, such as sets of two or more, four or more, six or more, eight or more, or other groups of cell envelope proteins as set forth in Table 2. In one particular embodiment, the microarray consists essentially of the proteins set forth in Table 2. In another particular embodiment, the microarray consists essentially of the proteins set forth in Table 1.

In other embodiments of the invention, methods are now available for assessment of cell surface proteins of B. burgdorferi as potential candidates for development of a diagnostic test for Lyme disease, and also for assessment of cell surface proteins of B. burgdorferi as potential candidates for development of vaccines to protect against Lyme disease. In both of these methods, one or more cell surface proteins of B. burgdorferi, such as sets of cell surface proteins as described herein (e.g., in a microarray as described above), are exposed to sera from one or more individuals known to have Lyme disease, and the proteins to which antibodies from the sera bind are then determined. For example, Cy5 intensity/Cy5 intensity ratio of fluorescence, as described in the Exemplification, can be used. The ratio of any proteins greater than the mean ratio of the reactivity of the Lyme sera to a negative control plus three times the standard deviation indicates significant interactions between antibodies present in the Lyme sera and the B. burgdorferi protein. Such proteins are proteins which can be used in diagnostic tests for Lyme disease (e.g., in the methods described above), as well as in microarrays as described herein, and also can be used as potential vaccine candidates.

Furthermore, the cell envelope proteins identified herein as reacting with sera of individuals with Lyme disease (e.g., those shown in Table 1 and/or Table 2) are useful as vaccine immunogens against Borrelia infection. Thus, the present invention is also drawn to pharmaceutical compositions which can be used to vaccinate and/or treat Borrelia infection in an animal or human. In a particular embodiment, the pharmaceutical composition comprises a Borrelia burgdorferi cell envelope protein, such as one shown in Table 1 or 2, or a protein derived from such a cell envelope protein (e.g., a cell envelope protein having modifications such as insertions, deletions, or other alterations, or a cell envelope protein that forms part of a chimeric protein, such as those described in U.S. Pat. Nos. 6,248,562; 7,008,625; 7,060,281; and 7,179,448, the entire teachings of which are incorporated herein by reference). The pharmaceutical composition can also be administered together with a physiologically-acceptable carrier, an excipient and/or an adjuvant. Suitable adjuvants are well known in the art (see for example PCT Publication WO 96/40290, the entire teachings of which are incorporated herein by reference), and can be used, for example, to enhance immunogenicity, potency or half-life of the proteins in the treated animal.

The pharmaceutical compositions used to vaccinate and/or treat Borrelia infection can be prepared using methods for preparing vaccines which are well known in the art. For example, the cell envelope proteins described herein can be isolated and/or purified by known techniques, such as by size exclusion chromatography, affinity chromatography, ion exchange chromatography, preparative electrophoresis, selective precipitation or combinations thereof. The prepared cell envelope proteins can be mixed with suitable other reagents as described herein, such that the cell envelope protein is at a suitable concentration. The dosage of the cell envelope protein will vary and depends upon the age, weight and/or physical condition of the animal, e.g., mammal, human, to be treated. The optimal dosage can be determined by routine optimization techniques, using suitable animal models.

Administration of the pharmaceutical composition to be used as a vaccine can be by any suitable technique. Suitable techniques for administration of the pharmaceutical composition include, but are not limited to, injection, e.g., subcutaneous injection, intramuscular injection, intravenous injection, intra peritoneal injection; mucosal administration, e.g., exposing nasal mucosa to nose drops containing the cell envelope proteins of the present invention; oral administration; and DNA immunization.

The present invention is also drawn to diagnostic kits which comprise the cell envelope proteins described herein (e.g., in a microarray as described above). The kit also includes reagents for detecting antibody-antigen complexes that are formed between the cell envelope protein and antibodies that are present in a sample, e.g., a user-supplied host sample.

### EXEMPLIFICATION

To determine the cell envelope proteins of Borrelia burgdorferi recognized by immune sera of patients with late Lyme disease, a microarray was developed containing proteins encoded by 90 cell envelope genes and their homologs described in the annotated genomic sequence of B. burgdorferi, strain B31 (see, e.g., Fraser, C. M. et al. 1997, Nature 390(6660):580-6). (See also GenBank Accession numbers AE000789.1, AE000786.1, AE001580.1, AE001575.1, AE000790.1, AE001576.1, AE000788.1, AE000784.1, AE001578.1, AE000787.1, AE001577.1, AE000783.1, AE001582.1, AE001579.1, AE000785.1, AE000793.1, AE001581.1, AE000792.1, AE000791.1, AE000794.1, AE001583.1 and AE001584.1. The teachings of these Accession numbers are incorporated herein in their entirety.)

Materials and Methods

Serum samples. Sera were obtained from patients who participated in multicenter clinical trials conducted by the Lyme Disease Center at Stony Brook University. The serum samples were obtained singly from different subjects and all serum samples were obtained from physician-characterized patients under established guidelines with prior approval by the Committee on Research Involving Human Subjects, Stony Brook University. The samples used included a total of 13 sera from patients with late Lyme disease (Lyme arthritis or neuroborreliosis) and all tested positive for B. burgdorferi antibodies by ELISA. Normal control sera were obtained from 4 healthy donors.

Borrelia cultivation and DNA Isolation. A B. burgdorferi B31 early passage strain containing all 21 known circular and linear plasmids was used as the source of total genomic DNA (Xu Y. et al., Microb. Path. 2003; 35:269-78). Spirochetes were cultivated at 34° C. to the mid-logarithmic phase in complete Barbour-Stoenner-Kelly (BSK-H) medium. B. burgdorferi genomic DNA was isolated from late-logarithmic phase B31 by using the Qiagen Genomic-tip 500 DNA purification columns (Dunn, J. J. et al., Protein Expr. Purif. 1990; 1:159-68). In addition, B. burgdorferi isolates recovered from human patients and typed for OspC phyletic group (referred to below as OspC types) were also used in this analysis and have been described (Attie, 0. et al., Infect. Gen. Evo. 2007; 7:1-12).

PCR amplification of Borrelia Lipoprotein genes. Approximately 90 ORFs encoding putative cell membrane proteins were amplified by using gene-specific primers designed from the genomic sequence of B. burgdorferi B31. Ten ng of genomic DNA was used as template in a 50-μl PCR reaction containing two ORF-specific primer pairs with different restriction sites for cloning into the T7-based expression vector pET-30 (Novagen). This vector also provides an N-terminal poly (His) affinity tag to expressed proteins to aid in purification on nickel-Sepharose columns. The 5′ primer (5′-ACAGGATCCCATGGCC+15MER ORF specific sequence) (SEQ ID NO:1) contained a NcoI site (bold). The 3′ primer (5′-GGATCGCGGCCGCTACTCGAG+15mer ORF specific) (SEQ ID NO:2) contained a NotI recognition sequence (bold). To increase the solubility properties of expressed proteins, primer sets were designed to amplify coding regions without a membrane anchoring signal sequence (Dunn, J. J. et al., Protein Expr. Purif 1990; 1:159-68). PCR amplification was performed under stringent conditions using Platinum Taq DNA polymerase High Fidelity (Invitrogen) using conditions we have previously described (Xu Y. et al., Microb. Path. 2003; 35:269-78). The PCR products were visualized by agarose gel electrophoresis. For quantification, the products were purified (PCR purification kit, Qiagen) and quantified by fluorometry. In addition, representatives of several different OspC types were amplified as described above from human isolates that we have previously characterized (Attie, O. et al., Infect. Gen. Evo. 2007; 7:1-12). The OspC types included in this study were types A, B, C, D, E, H, I, J, K and U.

For directional cloning into the pET-30 vector, amplified products were cleaved with NcoI and NotI and inserted between the NcoI and NotI sites of pET-30 for N-terminal His-tagged proteins. Ligation reactions were transformed into E. coli GC5 competent cells and plasmids were purified using Eppendorf Perfectprep Plasmid 96 VAC Direct Bind Kit.

Protein expression and purification. Purified plasmids were transformed into E. coli BL21/DE3 competent cell for expression. Borrelia proteins containing an N-terminal poly (His) affinity tag were expressed using the Overnight Express Autoinduction protocol (Studier, W. F. et al., Protein Express. Purif: 2005; 41:207-34). Induced cells were harvested by centrifugation and resuspended in BugBuster Protein Extraction Reagent. Following clarification by centrifugation, the supernatants were saved (soluble proteins) and cell pellets were resuspended in His-binding buffer with 8M urea (insoluble proteins). Aliquots of both supernatants and pellets were run on SDS-PAGE.

N-terminal poly His-tagged proteins were purified on nickel-Sepharose columns under either native conditions (soluble proteins) or strong denaturing conditions (insoluble proteins) using RoboPop Ni-NTA His·Bind Purification Kit (Novagen). The kit is designed for filtration-based 96-well format purification of His·Tag fusion proteins.

Protein concentration was determined by the measurement of the absorbance shift when Coomassie brilliant blue G-250 reacted with protein (Bio-Rad). Protein purity was checked by SDS-PAGE.

Microarray. For microarray, proteins were printed onto nitrocellulose-coated FAST glass slides using a Microcaster 8-pin Microarray Printer. Each slide in the arrays contained 10 immobilized BSA spots for background determination and 8 immobilized His-tagged hGS2 spots, a human lipase protein, for use as a negative control. Proteome chips were probed with serum from B. burgdorferi infected patients (positive for Bb by ELISA) using the Fast Pak protein array kit. Briefly, slides were first blocked overnight at 4° C. in protein array-blocking buffer before incubation in primary Antibody (human sera and mouse anti His-Tag for quantitation) for 2 h. Antibodies were visualized with Cy5-conjugated goat anti-human IgG/IgM/IgA and Cy₃-conjugated goat anti mouse IgG and the slides were stringently washed and then scanned with an Axon GenePix 4200A microarray scanner and raw data was captured and analyzed with GenePix Pro image analysis software. To minimize the variability among samples, the PMT gain was adjusted to equal 1.0 in all the arrays with power setting at 50%. A global background subtraction method was used to subtract the background from each spot using the average mean intensity value of BSA from each slide.

Data analysis. For analysis of the data generated from the arrays with human serum, the spot was considered positive and included for further ratio analysis if the median fluorescence intensity of a spot was more than 1000 and the SNR (signal-noise-ratio) of a spot was more than 4. A ratio Cy5 intensity/Cy3 intensity (protein/His-tag) for each protein was then calculated. All experiments were conducted two times, and each proteins Cy5/Cy3 ratios were averaged. The ratio of any proteins greater than the mean ratio of the reactivity of the Lyme sera to the GS2 negative control plus three times the standard deviation indicates significant interactions between antibodies present in the Lyme sera and immobilized B. burgdorferi protein.

Results and Discussion

The majority of B. burgdorferi membrane-associated proteins are lipoproteins that represent more than 8% of Borrelia's total coding capacity (Beermann, C. et al., Biochem. Biophys. Res. Commun. 2000; 267:897-905). Because of their importance as antigens and mediators of inflammation (Radolf, J. D. et al., J. Immunol. 1995; 154:2866-77) these membrane-associated proteins are of significant interest as potential vaccine targets. To identify antigens important in the human immune response to Lyme disease, a protein microarray was used to examine the serum antibody reactivity of Lyme patients with 90 Borrelia burgdorferi cell envelope proteins.

To fabricate protein microarray chips, each ORF was PCR amplified and directionally cloned into the T7 expression vector pET28b. Sequenced-confirmed plasmids were expressed using the overnight expression system, expressed proteins were purified using His resin and printed onto nitrocellulose coated FAST slides. The PCR strategy was designed to subclone a version of each membrane protein without a N-terminal signal sequence. In preliminary studies, full-length gene products appeared to be toxic when over expressed in E. coli. As a result, target proteins did not accumulate to very high levels. The truncated form of each protein lacking a signal sequence proved to be excellent over producers. (Dunn, J. J., et al., Protein Expr. Purif. 1990; 1:159-68)

When arrays were probed with sera from 13 Lyme disease patients, a considerable amount of heterogeneity was observed in reactivity of individual sera samples to the arrayed proteins (see Table 2). Of the 90 antigens, only one, BBP28, was recognized by all 13 sera samples. Three antigens, BBN39, BBO40, and BBK50, were recognized by 12 of 13 samples. Although seventy-six of the arrayed antigens were recognized by at least one sample, less than half were recognized by more than six patients. Considerable heterogeneity was also noted among arrayed proteins showing the highest seroreactivity. Of those antigens displaying the highest C5/C3 signal intensity ratios, antigens BBA25 (DbpB), BBE31 (putative P35) and BB0383 (bmpA) were recognized by less than half of the individuals. Sera from noninfected humans did not react with any of the antigens on the array (data not shown).

Although there were sample-specific responses, there was a subset of proteins recognized in common by a majority of the sera. The 25 most immunodominent antigens found in this study are presented in Table 1. Several of the 25 antigens we identified were previously reported as antigens in humans. Included are several members of the Erp gene families which code for proteins that bind to mammalian complement inhibitor factor H and Decorin-binding protein (DbpA), a borrelial surface lipoprotein that function as an adhesin promoting bacterial attachment to host cells (Casjens, S. et al., Mol Microbiol. 2000; 35, 490-516; Miller, J. C. et al., J. Clin. Microbiol. 2000; 38:1569-74; von Lackum, K. et al., Infect. Immun. 2005; 73: 7398-05; and Cinco, M. et al., FEMS Microbiol. Lett. 2000; 183:111-4). Late disseminated sera also recognized the previously established immunogens, export protein A (BBC06), P35 (BBJ41), P37 (BBK50), OspA (BBA15) and OspC (BBB19) (Fikrig, E. et al., Science; 1990:250:553-6; Funhg, B. P. et al., Infect. Immun. 1994; 62:3213-21; Champion, C. I. et al., Infect. Immun. 1994; 62: 2653-61; Aguero-Rosenfeld, M. E. et al., J. Clin. Microbiol. 1996; 34:1-9; Nowalk, A. J. et al., Infect. Immun. 2006 July; 74:3864-73).

Several members of the Borrelia gene family Pfam 113 exhibited strong immunoreactivity to late disseminated human sera (Casjens, S. et al., Mol Microbiol. 2000; 35, 490-516). This lipoprotein gene family designated Mlp lipoproteins are found on both circular and linear plasmids and include BBP28, BBL28, BB028, BBS30, BBM28 and BBN28 (Table 1). The mlp genes encode a diverse array of lipoproteins that are highly antigenic and may participate in infection processes in the mammalian host (Porcella, S. F. et al., Infect. Immun. 2000; 68: 4992-5001). Similarly, BBI42, shown to be immunogenic in a previous study with baboon sera, was highly reactive with human sera (Brooks, C. S. et al., Infect. Immun. 2006 July; 74:206-304).

To determine if the human antibody response to OspC was type specific, recombinant Osp C types A, B, C, D, E, H, I, J, K and U were generated and included as antigens in the protein array. As shown in Table 1, OspC (BBB19) was highly immunogenic in 9 of 13 sera from Lyme patients. There was no evidence found; however, of OspC type specificity in late-disseminated sera. All OspC types within a given serum sample were recognized with essentially equal signal intensities (Table 2).

Among the novel, uncharacterized B. burgdorferi antigens identified in this study were BBA14 (lipoprotein), BBG23 (hypothetical protein), BB0108 (lipoprotein), BB0442 (inner membrane protein) and BBQ03 (putative outer membrane protein).

TABLE 1
Borrelia burgdorferi cell envelope proteins showing highest reactivity
to sera from patients with late disseminated Lyme Disease
as shown by protein microarray

| | Gene | | C5/C3 | # of Positive |
|---|---|---|---|---|
| Locus | Symbol | Protein Name | Ratio | Sera |
| BBP28 | mlpA | Lipoprotein | 1.8 | 13 |
| BBN39 | erpB2 | erpB2 protein | 4.6 | 12 |
| BBO40 | erpM | ErpM protein | 1.7 | 12 |
| BBK50 | — | Immunogenic protein P37, | 2.1 | 12 |
| | | putative | | |
| BBA24 | dbpA | Decorin binding protein A | 26.0 | 11 |
| BBJ09 | ospD | Outer surface protein D | 2.3 | 11 |
| BBL28 | mlpH | Lipoprotein | 1.0 | 11 |
| BBI42 | — | Outer membrane protein, | 7.6 | 10 |
| | | putative | | |
| BBQ47 | erpX | ErpX protein | 1.9 | 10 |
| BBO39 | erpL | ErpL protein | 1.2 | 10 |
| BBO28 | mlpG | Lipoprotein | 1.4 | 10 |
| BBC06 | eppA | Exported protein A | 16.2 | 9 |
| BBS41 | erpG | Outer surface protein G | 8.2 | 9 |
| BBR42 | erpY | Outer surface protein F | 5.5 | 9 |
| BBQ03 | — | Outer membrane protein, | 4.6 | 9 |
| | | putative | | |
| BBJ41 | — | Antigen, P35, putative | 4.0 | 9 |
| BBA15 | ospA | Outer surface protein A | 3.7 | 9 |
| BBB19 | ospC | Outer surface protein C | 3.9 | 9 |
| BBS30 | mlpC | Lipoprotein | 2.5 | 9 |
| BBM28 | mlpF | Lipoprotein | 1.9 | 8 |
| BBG23 | | Hypothetical protein | 1.4 | 8 |
| BBN28 | mlpI | Lipoprotein | 1.1 | 8 |
| BB0108 | | Lipoprotein | 3.1 | 7 |
| BB0442 | | Inner membrane protein | 4.8 | 7 |
| BBA14 | | Lipoprotein | 2.1 | 7 |

Table 2 indicates all of the proteins identified by serum antibodies from individuals with Lyme disease.

TABLE 2
Binding of human serum antibodies from late-disseminated Lyme disease
to B. burgdorferi proteins

| | | | | # |
|---|---|---|---|---|
| | Gene | | C5/C3 | of positive |
| Locus | Symbol | Protein name | Ratio | sera |
| BB 0028 | | Lipoprotein, putative | 3.06 | 4 |
| BB 0108 | | Basic membrane protein | 1.85 | 7 |
| BB0158 | | Antigen, S2, putative | 2.70 | 5 |
| BB0159 | | Antigen S2-related protein | 3.16 | 1 |
| BB 0213 | | Lipoprotein, putative | 1.51 | 2 |
| BB 0224 | | Lipoprotein, putative | 2.56 | 4 |
| BB 0319 | Tpn38b | Exported protein | 2.33 | 1 |
| BB0365 | | Lipoprotein LA7 | 3.57 | 6 |
| BB 0382 | bmpB | Basic membrane protein B | 1.72 | 2 |
| BB 0383 | bmpA | Basic membrane protein A | 9.33 | 5 |
| BB 0442 | | Inner membrane protein | 4.47 | 7 |
| BB 0475 | | Lipoprotein, putative | 2.00 | 6 |
| BB 0735 | rlpA | Rare lipoprotein A | 1.96 | 4 |
| BB 0758 | | Lipoprotein, putative | 5.34 | 5 |
| BB 0832 | | Lipoprotein, putative | 1.88 | 2 |
| BB A03 | | Outer membrane protein | 1.79 | 5 |
| BB A04 | | Antigen, S2 | 2.59 | 3 |
| BB A05 | | Antigen, S1 | 4.90 | 1 |
| BB A14 | | Lipoprotein, putative | 2.08 | 7 |
| BB A15 | ospA | Outer surface protein A | 3.73 | 9 |
| BB A16 | ospB | Outer surface protein B | 5.54 | 6 |
| BB A24 | dbpA | Decorin binding protein A | 25.98 | 11 |
| BB A25 | dbpB | Decorin binding protein B | 19.30 | 5 |
| BB A36 | | Lipoprotein | 0.85 | 6 |
| BB A52 | | Outer membrane protein | 0.72 | 4 |
| BB A59 | | Lipoprotein | 3.48 | 2 |
| BB A60 | | Surface lipoprotein P27 | 3.34 | 6 |
| BB A64 | | Antigen, P35 | 2.55 | 3 |
| BB A66 | | Antigen, P35, putative | 3.12 | 1 |
| BB C06 | eppA | Exported protein A | 16.15 | 9 |
| BB E09 | | Protein p23 | 0.50 | 1 |
| BB E31 | | Antigen, P35, putative | 9.95 | 5 |
| BB G22 | | Hypothetical protein | 3.86 | 6 |
| BB G23 | | Hypothetical protein | 1.22 | 8 |
| BB H32 | | Antigen, P35, putative | 4.37 | 3 |
| BB I36 | | Antigen, P35, putative | 4.70 | 7 |
| BB I42 | | Outer membrane protein, | 7.63 | 10 |
| | | putative | | |
| BB J09 | ospD | Outer surface protein D | 2.32 | 11 |
| BB J19 | | Conserved hypothetical | 20.36 | 1 |
| | | protein | | |
| BB J41 | | Antigen, P35, putative | 4.03 | 9 |
| BB K32 | | Immunogenic protein P35 | 4.30 | 3 |
| BB K45 | | Immunogenic protein P37, | 0.67 | 1 |
| | | putative | | |
| BB K48 | | Immunogenic protein P37, | 1.63 | 4 |
| | | putative | | |
| BB K50 | | Immunogenic protein P37, | 1.05 | 12 |
| | | putative | | |
| BB K52 | | Protein p23 | 1.10 | 1 |
| BB K53 | | Outer membrane protein | 6.41 | 7 |
| BB L28 | | Lipoprotein | 0.97 | 11 |
| BB M28 | Lp | Lipoprotein | 1.85 | 8 |
| BB M38 | erpK | erpK protein | 1.03 | 2 |
| BB N26 | | Outer surface protein, | 0.60 | 4 |
| | | putative | | |
| BB N28 | Lp | Lipoprotein | 1.09 | 8 |
| BB N38 | erpA | ErpA protein | 0.74 | 3 |
| BB N39 | erpB2 | erpB2 protein | 4.60 | 12 |
| BB O28 | Lp | Lipoprotein | 1.13 | 10 |
| BB O39 | erpL | erpL protein | 1.22 | 10 |
| BB O40 | erpM | erpM protein | 1.70 | 12 |
| BB P28 | | Lipoprotein | 1.72 | 13 |
| BB P38 | erpA | erpA protein | 1.35 | 6 |
| BB Q03 | | Outer membrane protein, | 4.59 | 9 |
| | | putative | | |
| BB Q04 | | Protein p23 | 1.54 | 1 |
| BB Q35 | nlpH | Congo red-binding | 0.98 | 7 |
| | | lipoprotein NlpH | | |
| BB Q47 | erpX | ErpX protein | 1.86 | 10 |
| BB R28 | Lp | Lipoprotein | 1.27 | 7 |
| BB R42 | erpY | Outer surface protein F | 5.46 | 9 |
| BB S30 | Lp | Lipoprotein | 2.45 | 9 |
| BB S41 | erpG | Outer surface protein G | 8.20 | 9 |
| OspC type C | | | 4.79 | 7 |
| OspC type E | | | 4.39 | 8 |
| OspC type J | | | 3.65 | 8 |
| OspC type I | | | 3.48 | 9 |
| OspC type K | | | 6.25 | 8 |
| OspC type U | | | 3.78 | 9 |
| OspC type B | | | 3.66 | 8 |
| OspC type D | | | 5.11 | 7 |
| OspC type H | | | 3.95 | 7 |
| OspC type A | ospC | Outer surface protein C | 2.84 | 9 |

Table 3 indicates B. Burgdorferi arrayed proteins that were negative to sera from Lyme disease patients

TABLE 3
Proteins negative to sera

| | Gene | |
|---|---|---|
| Locus | symbol | Protein name |
| BB0382 | bmpB | basic membrane protein B |
| BB0384 | bmpC | basic membrane protein C |
| BB0385 | bmpD | basic membrane protein D |
| BB0442 | | membrane-associated protein |
| BB0603 | | membrane-associated protein p66 |
| BB0758 | | lipoprotein, putative |
| BB0840 | | lipoprotein, putative |
| BBA73 | | antigen, P35, putative |
| BBB07 | | outer surface protein, putative |
| BBK37 | | immunogenic protein P37 |
| BBK46 | | immunogenic protein P37 |
| BBQ47 | | outer membrane protein |

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for assessing a test sample from an individual for the presence of antibodies to one or more cell envelope proteins of Borrelia burgdorferi, comprising exposing the test sample to one or more proteins selected from the group consisting of the proteins shown in Table 1, and assessing the test sample for binding of antibodies to said protein(s).

2. The method of claim 1, wherein the test sample from the individual is assessed for the presence of antibodies to each of the proteins shown in Table 1.

3. The method of claim 1, wherein the assessment of the test sample includes the use of a microarray comprising the protein(s).

4. The method of claim 1, wherein the microarray comprises all of the proteins shown in Table 1.

5. A method for assessing a test sample from an individual for the presence of antibodies to one or more cell envelope proteins of Borrelia burgdorferi, comprising exposing the test sample to one or more proteins selected from the group consisting of the proteins shown in Table 2, and assessing the test sample for binding of antibodies to said protein(s).

6. The method of claim 5, wherein the test sample from the individual is assessed for the presence of antibodies to each of the proteins shown in Table 2.

7. The method of claim 5, wherein the assessment of the test sample includes the use of a microarray comprising the protein(s).

8. The method of claim 5, wherein the microarray comprises all of the proteins shown in Table 2.

9. A method for diagnosing Lyme disease in an individual, comprising assessing a test sample from the individual for the presence of antibodies to one or more cell envelope proteins, wherein the presence of said antibodies is diagnostic for Lyme disease.

10. The method of claim 9, wherein a cell envelope protein is selected from the group consisting of the proteins shown in Table 1.

11. The method of claim 9, wherein a cell envelope protein is selected from the group consisting of the proteins shown in Table 2.

12. The method of claim 9, wherein the test sample from the individual is assessed for the presence of antibodies to at least two cell envelope proteins selected from the group consisting of the proteins shown in Table 2.

13. The method of claim 9, wherein the test sample from the individual is assessed for the presence of antibodies to at least four cell envelope proteins selected from the group consisting of the proteins shown in Table 2.

14. The method of claim 9, wherein the test sample from the individual is assessed for the presence of antibodies to each of the proteins shown in Table 1.

15. The method of claim 9, wherein the test sample from the individual is assessed for the presence of antibodies to each of the proteins shown in Table 2.

16. The method of claim 9, wherein the assessment of the test sample includes the use of a microarray comprising the protein(s).

17. The method of any of claim 1, 5, or 9, wherein at least one protein is a protein with an open reading frame at a locus selected from the group consisting of: BBP28, BBN39, BBO40 and BBK40.

18. The method of any of claim 1, 5, or 9, wherein at least one protein is a protein with an open reading frame at a locus selected from the group consisting of: BBA25, BBE31, and BB0383.

19. The method of claim 16, wherein the microarray comprises all of the proteins shown in Table 1.

20. The method of claim 16, wherein the microarray comprises all of the proteins shown in Table 2.

21. A microarray comprising the cell envelope proteins shown in Table 1.

22. A microarray comprising the cell envelope proteins shown in Table 2.


SEQUENCE LISTING (2 sequences)

SEQ ID NO: 1 - DNA, 16 bp, Borrelia burgdorferi
acaggatcccatggcc

SEQ ID NO: 2 - DNA, 21 bp, Borrelia burgdorferi
ggatcgcggccgctactcgag